(19) United States
(12) Patent Application Publication
(10) Pub. No.: US 2013/0193697 A1
(43) Pub. Date: Aug. 1, 2013

(54) VEHICLE BODY PANEL LATCH WITH REMOTE ACTUATOR

(71) Applicants: Riccardo Spadoni, Forli (IT); Gianluca Fava, Modena (IT); Ivano Resea, S. Giovanni in Persiceto (IT); Franco Rota, Botticino (IT)

(72) Inventors: Riccardo Spadoni, Forli (IT); Gianluca Fava, Modena (IT); Ivano Resea, S. Giovanni in Persiceto (IT); Franco Rota, Botticino (IT)

(73) Assignee: CNH Amercia LLC

(21) Appl. No.: 13/519,108

(22) PCT Filed: Dec. 21, 2010
(86) PCT No.: PCT/EP2010/070343

§ 371 Date: Oct. 24, 2012

(30) Foreign Application Priority Data
Dec. 28, 2009 (IT) TO2009A001046

(51) Int. Cl. E05B 65/12

(52) U.S. Cl. CPC E05B 83/24
USPC 292/336.3

(57) ABSTRACT

A vehicle having an openable body panel and a latch with a pivotable release lever for holding the panel in a closed position is provided with an actuator for remotely releasing the latch. The actuator comprises a rod coupled at one end to the release lever of the latch. The other end of the 0rod is connected to an element which may include a ball rigidly secured to the end of the force transmitting member that is slidably received within a tubular socket fitted within a hole in the body panel. The element is recessed within the socket so as not to protrude beyond the outer surface of the body panel.

### CROSS REFERENCE TO RELATED APPLICATIONS

This application is the US National Stage filing of International Application Serial No. PCT/EP2010/070343, filed on Dec. 21, 2010, which claims priority to Italian Application Serial No. TO2009A001046, filed Dec 28, 2009, each of which is incorporated herein by reference in its entirety for all purposes.

### FIELD OF THE INVENTION

The present invention relates to a vehicle having an openable body panel, a latch with a pivotable release lever for holding the panel in a closed position, and an actuator for remotely releasing the latch. The invention has particular application to latch of the hood of a tractor.

### BACKGROUND OF THE INVENTION

The hood (also termed a bonnet) of a tractor may be held closed by a latch that includes a pivoted catch plate interacting with a striker pin on the chassis of the tractor. The latch has a release lever which needs to be pivoted in order to release the catch plate from the striker pin, to allow the hood to be opened. The latch is not usually mounted in a position where the release lever can be directly accessed by the vehicle operator and in order to open the hood a remote actuator is required.

Currently, a rigid rod is pivotably connected to the release lever of the latch and passes through a hole in the hood. A rubber button is fitted to the end of the rod which, when depressed, moves the rod and pivots the release lever to the open position. This provides an inexpensive remote latch actuator which is installed in many modern tractors.

This simple design of a remote actuator does, however, suffer from certain shortcomings. The button protruding from the hood can be knocked both by the operator and by branches hitting the hood as the tractor is being driven. Such impacts can deform the hood around the button, with a consequent misalignment of the rod. The rubber button may separate from the hood exposing sharp metal edges that can cause injury to the operator and it may become difficult to release the latch. The protruding rubber button also permits the hood latch to be released accidentally or by an inexperienced person or a child, with consequent safety problems. Yet another problem is that the rod and the hole in the hood through which it passes may not align correctly on account of manufacturing tolerances and this can make it difficult to release the latch.

The present invention seeks to provide a vehicle body panel with a remote latch release that mitigates at least some of the foregoing problems.

### SUMMARY OF THE INVENTION

According to the present invention, there is provided a vehicle having an openable body panel, a latch with a pivotable release lever for holding the panel in a closed position, and an actuator for remotely releasing the latch, the actuator comprising a force transmitting member coupled at a first end to the release lever of the latch, characterised in that the other end of the force transmitting member is coupled to an element that is slidably received within an inner bore of a socket fitted within a hole in the body panel, the bore being open at both ends and the element being recessed within the socket so as not to protrude beyond the outer surface of the body panel.

The force transmitting member is preferably a rigid rod and will hereinafter be referred to simply as a rod. It may however take the form of a Bowden cable, if there is an obstruction that precludes the use of a rigid rod.

To release the latch in the present invention, the slidable element connected to the end of the rod needs to be depressed in the same way as the protruding button which in the prior art is fitted to the end of the rod. However, in the present invention, the slidable element is recessed within the tubular socket and cannot be knocked accidentally.

It is preferable for at least part of the inner bore of the tubular socket to be too small to receive a human finger, for example less than about 1 cm wide, necessitating the insertion of a suitable key or a thin implement into the bore of the socket to push the slidable element. This reduces the likelihood of the panel being opened by an unauthorised or an inexperienced person.

Though the term “bore” is used herein to refer to the inner passage through the tubular socket, it should be specified that this passage need not have a circular cross section. Indeed, it is preferable for it to have a hexagonal cross section to enable the socket to be gripped and prevented from rotating during its mounting on the body panel.

Preferably, the slidable element is so constructed as to allow the rod to pivot freely relative to the longitudinal axis of the socket. This will permit the rod to move freely even if it is misaligned with the axis of the socket on account of deformation of the body panel or manufacturing tolerances.

Such a pivoting motion of the rod may conveniently be achieved by forming the slidable element as a ball rigidly secured to the end of the rod. It is alternatively possible, however, for the slidable element to be a cylindrical body connected to the end of the rod by means of a ball joint.

The socket may advantageously be formed as an externally threaded tube having a flanged outer end and secured to the body panel by means of an internally threaded nut, the body panel being sandwiched between the nut and the flanged end of the socket.

If the body panel is not flat in the region where the socket is fitted, it is possible to provide conformable sealing washers between the body panel and the flanged end of the socket on one side and between the body panel and the nut on the other side.

To assist in fitting the socket to the body panel, the hole into which the socket is fitted may be non-circular and one of the socket and the nut may have a region received in the hole that prevents it from turning relative to the panel, the other being rotatable to clamp the body panel between the nut and the flanged end of the socket.

To prevent dirt from entering the inner bore of the socket, which might interfere with free movement of the slidable element, it is possible to provide a blanking plug and the latter may if desired be connected to the flanged end of the socket by means of a live hinge.

### BRIEF DESCRIPTION OF THE DRAWINGS

The invention will now be described further, by way of example, with reference to the accompanying drawings, in which:

FIG. 1 is a section through a remote actuator embodying the present invention.

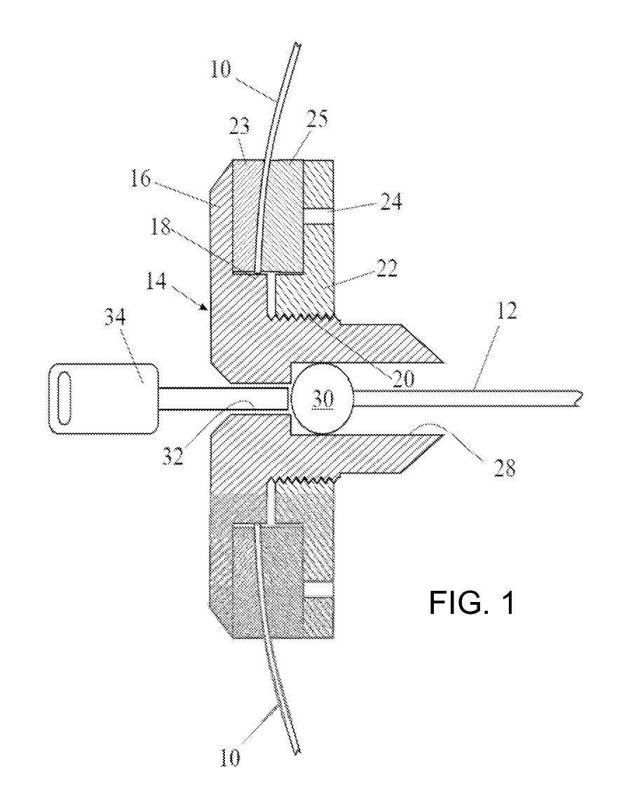

### DETAILED DESCRIPTION OF THE PREFERRED EMBODIMENT

The accompanying drawing shows part of a hood 10 of a tractor. A conventional latch (not shown) with a projecting pivoted release lever is mounted on the interior of the hood. To open the hood, the release lever has to be pivoted remotely from a point on the exterior side of the hood and the drawing shows only the remote actuator.

A rod 12 is connected at its end not shown in the drawing to the release lever of the latch. To release the latch, the rod 12 needs to be moved to the right, as viewed. In the prior art, the rod would project to the exterior through a hole in the hood and be fitted with a rubber button. However, for the reasons earlier outlined, such a projecting rubber button has many shortcomings and these are overcome by the illustrated embodiment of the invention.

A tubular socket 14 is mounted in a hole that is formed in the hood 10. Making the hole in the hood non-circular is preferred but not essential. At its left side, as viewed, the socket 14 has a flanged end 16 that cannot pass through the hole in the hood, whereas the remainder of the socket 14 can be inserted into the hole. Adjacent its flanged end 16, the socket 14 has a region 18 having the same cross section as the hole in the hood. If the hole is non-circular, then when this region 18 engages in the hole in the hood, the socket 14 cannot be rotated. A section region 20 of the socket 14 is externally threaded to engage with an internally threaded nut 22. By passing the socket 14 through the hole in the hood then screwing on the nut 22, the socket 14 is firmly clamped to the hood 10.

As the socket 14 and the nut 20 have flat clamping surfaces, conformable washers 23 and 25 are arranged on the opposite sides of the hole to allow for the fact that the hood may be contoured. The nut 22 has formations, such as holes 24 that can be engaged by a suitable spanner, to allow it to be tightened onto the socket 14 to compress the conformable washers 23 and 25 and retain the socket 14 firmly relative to the hood 10.

The inner bore 28 of the tubular socket 14 receives a ball 30 that is mounted on the end of the rod 12. The outer end of the bore 28 has a constricted neck 32 so that it will not accept a human finger. Instead, a key 34 or another slender implement, must be used to push the ball 30 and the rod 12 to the right in order to release the latch.

Because of the spherical nature of the ball 30, misalignment of the rod 12 with the axis of the bore 28 will not cause the remote actuator to jam. If another form of slidable element is used, for example a cylindrical body, the same advantage can be obtained by providing a ball joint between the slidable element and the rod 12.

To avoid the bore 28 becoming blocked, it is possible to close its outer end with a blanking plug (not shown). To avoid accidental loss of the blanking plug, it may be connected by a hinge to the flanged end 16 of the socket or to an additional washer interposed between the flanged end 16 and the conformable washer 23.

It will be clear to the person skilled in the art that many modifications may be made to the described and illustrated preferred embodiment of the invention without departing from the scope of the invention as set out in the appended claims. For example, though a screw and nut construction has been described for securing the socket to the hood, the socket could be pushed into a hole in the hood from one side and be formed with barbs engaging behind the edge of the hole to retain it within the hole. In such a construction, a single conformable washer would suffice to accommodate any contouring of the hood around the hole. Furthermore, the socket having a bore to receive the end of the rod could be mounted on the interior rather than the exterior of the hood, so that the socket and the nut may effectively be interchanged.

1. A vehicle including:
an openable body panel,
a latch with a pivotable release lever for holding the panel in a closed position, and
an actuator for remotely releasing the latch, the actuator comprising
a force transmitting member coupled at a first end to the release lever of the latch, an opposite end of the force transmitting member is coupled to an element slidably received within an inner bore of a socket fitted within a hole in the body panel, the bore being open at both ends and the element being recessed within the socket so as not to protrude beyond the outer surface of the body panel.

2. The vehicle of claim 1, wherein the force transmitting member is a rigid rod.

3. The vehicle of claim 2, wherein at least part of the inner bore of the socket is too narrow to permit a human finger to contact the force transmitting member.

4. The vehicle of claim 2, wherein the slidable element is constructed to allow the force transmitting member to pivot freely relative to the longitudinal axis of the socket.

5. The vehicle of claim 4, wherein the slidable element comprises a ball rigidly secured to the end of the force transmitting member.

6. The vehicle of claim 5, wherein the socket is formed as an externally threaded tube having a flanged outer end and secured to the body panel by means of an internally threaded nut, the body panel being sandwiched between the nut and the flanged end of the socket.

7. The vehicle of claim 6, wherein two conformable sealing washers are provided, one washer disposed between the body panel and the flanged end of the socket and the other washer disposed between the body panel and the nut.

8. The vehicle of claim 7, wherein the hole in the body panel into which the socket is fitted is non-circular and engages with a region of the socket to prevent the socket from rotating as the nut is tightened.

9. The vehicle of claim 8, wherein a blanking plug is provided to prevent dirt from entering the inner bore of the socket.

10. The vehicle of claim 9, wherein the blanking plug is connected by a hinge to the socket or to a washer trapped between the socket and the body panel.

11. A tractor, including:
an openable body panel comprising a hood,
a latch with a pivotable release lever for holding the panel in a closed position, and
an actuator for remotely releasing the latch, the actuator comprising
a force transmitting member coupled at a first end to the release lever of the latch, an opposite end of the force transmitting member coupled to a slidable element movably received within an inner bore of a socket fitted within a hole in the body panel, the bore being open at both ends and the element being recessed within the socket so as not to protrude beyond the outer surface of the body panel, wherein the slidable element comprises a ball rigidly secured to the end of the force transmitting member, and wherein the slidable element is constructed to allow the force transmitting member to pivot freely relative to the longitudinal axis of the socket.

12. The tractor is claim 11, wherein the force transmitting member is a rigid rod.

13. The tractor of claim 12, wherein at least part of the inner bore of the socket is too narrow to permit a human finger to contact the force transmitting member.

14. The tractor of claim 12, wherein the socket is formed as an externally threaded tube having a flanged outer end and secured to the body panel by means of an internally threaded nut, the body panel being sandwiched between the nut and the flanged end of the socket.

15. The tractor of claim 14, wherein two conformable sealing washers are provided, one washer disposed between the body panel and the flanged end of the socket and the other washer disposed between the body panel and the nut.

16. The tractor of claim 15, wherein the hole in the body panel into which the socket is fitted is non-circular and engages with a region of the socket to prevent the socket from rotating as the nut is tightened.

17. The tractor of claim 16, wherein a blanking plug is provided to prevent dirt from entering the inner bore of the socket.

18. The tractor of claim 17, wherein the blanking plug is connected by a hinge to the socket or to a washer trapped between the socket and the body panel.

19. A tractor hood, including:
an openable panel,
a latch with a pivotable release lever for holding the panel in a closed position, and
an actuator for remotely releasing the latch, the actuator comprising
a force transmitting member coupled at a first end to the release lever of the latch, an opposite end of the force transmitting member coupled to a slidable element movably received within an inner bore of a socket fitted within a hole in the body panel, the bore being open at both ends and the element being recessed within the socket so as not to protrude beyond the outer surface of the body panel, wherein the force transmitting member is a rigid rod and the slidable element comprises a ball rigidly secured to the end of the force transmitting member, and wherein the slidable element is constructed to allow the force transmitting member to pivot freely relative to the longitudinal axis of the socket.

20. The tractor of claim 18, wherein the socket is formed as an externally threaded tube having a flanged outer end and secured to the body panel by means of an internally threaded nut, the body panel being sandwiched between the nut and the flanged end of the socket, wherein two conformable sealing washers are provided, one washer disposed between the body panel and the flanged end of the socket and the other washer disposed between the body panel and the nut, and wherein the hole in the body panel into which the socket is fitted is non-circular and engages with a region of the socket to prevent the socket from rotating as the nut is tightened.
